(19) United States
(12) Patent Application Publication
(10) Pub. No.: US 2015/0040870 A1
(43) Pub. Date: Feb. 12, 2015

(54) Method for the Variable Adjustment of a Compression Ratio of a Combustion Chamber of an Internal Combustion Engine

(71) Applicants: Dieter Nowak, Weilheim (DE); Tilmann Roemheld, Waiblingen (DE); Michael Wagenplast, Schwaigern (DE)

(72) Inventors: Dieter Nowak, Weilheim (DE); Tilmann Roemheld, Waiblingen (DE); Michael Wagenplast, Schwaigern (DE)

(73) Assignee: Daimler AG, Stuttgart (DE)

(21) Appl. No.: 14/350,311

(22) PCT Filed: Sep. 4, 2012
(86) PCT No.: PCT/EP2012/003698

§ 371 Date: Oct. 27, 2014

(30) Foreign Application Priority Data
Oct. 8, 2011 (DE) 10 2011 115 415.2

(51) Int. Cl. F02B 75/04

(52) U.S. Cl. CPC F02B 75/045
USPC 123/48 B

(57) ABSTRACT

A method for variably adjusting a compression ratio of combustion chamber of an internal combustion engine employs a device of a piston associated with the combustion chamber. The device is coupled via respective coupling areas to a piston pin for connecting the piston to a connecting rod of the internal combustion engine. To adjust the compression ratio the piston pin, which is associated with the device, is rotated relative to the piston. The piston pin includes at least one eccentric element arranged eccentrically with regard to the coupling area of the piston pin for connecting the piston pin to the connecting rod.

### BACKGROUND AND SUMMARY OF THE INVENTION

Exemplary embodiments of the invention relate to a method for variably adjusting a compression ratio of a combustion chamber of an internal combustion engine.

German patent document DE 10 2009 048 172 A1 discloses a piston for an internal combustion engine that has a changeable compression ratio, the piston comprising a first piston part and a second piston part. The piston parts are coupled to each other to be movable relative to each other, thereby forming at least a first chamber that can be pressurized with a pressure medium, in particular a pressure fluid, and that is changeable in terms of its volume. At least one switchable valve device is arranged on the inside of the piston skirt of the piston, by means of which valve device a volume of the pressure medium in the first chamber can be adjusted.

PCT patent document WO2010/124971 shows an apparatus for modifying the piston kinematics of an internal combustion engine having at least one piston reciprocating in a cylinder that is connected in a swiveling manner to a connecting rod by means of a piston pin, wherein the piston pin is rotatably mounted in at least one piston pin bearing of the piston and also in a connecting rod bearing of the connecting rod, wherein the piston pin comprises an eccentric in at least one bearing area of the piston pin bearing and/or the connecting rod bearing, and wherein the piston pin can be rotated by a rotating device. The rotating device is formed by a torsion spring and that the piston pin can be rotated from a rest position to at least one pressure limiting position against the force of the torsion spring.

Furthermore, patent documents EP 219 634 A2, EP 297 904 A2, U.S. Pat. No. 4,687,348 A, U.S. Pat. No. 5,417,185 A and DE 10 2005 055199 A1 show connections between pistons and connecting rods in internal combustion engines, wherein the connection consists of a piston pin that is eccentric at least over a portion of its longitudinal extent. A rotational movement of the piston pin effects a change of a compression ratio of the internal combustion engine, and is enabled or prevented by means of a switchable locking element.

Exemplary embodiments of the present invention are directed to a method for variably adjusting a compression ratio of a combustion chamber of an internal combustion engine that allows a particularly simple adjustment or readjustment of the compression ratio.

In the case of such a method for variably adjusting a compression ratio of a combustion chamber, in particular of a cylinder, of an internal combustion engine that is configured, for example, as a reciprocating piston engine, the compression ratio is adjusted or readjusted by means of a device of the piston that is associated with the combustion chamber. The piston is coupled to a piston pin via respective coupling areas. The piston can be connected to a connecting rod of the internal combustion engine via the piston pin.

In the respective coupling areas, the piston pin is received, for example, in the piston. Likewise, the piston pin is received in the connecting rod, at least in certain areas. Due to the articulated coupling of the piston to the connecting rod via the piston pin, the piston can be coupled in an articulated manner to a crankshaft of the internal combustion engine, which crankshaft is mounted in a crankcase to be rotatable about a rotational axis relative to the crankcase. Thus, translational movements of the piston in the combustion chamber relative to the combustion chamber can be converted into a rotational movement of the crankshaft about the rotational axis.

According to the invention adjusting the compression ratio is achieved by a rotation of the piston pin associated with the device. For this, the piston pin has at least one eccentric element arranged eccentrically with regard to the at least one coupling area of the piston pin and via which the piston pin is to be connected to the connecting rod.

If the eccentric element, which is received at least in certain areas in the connecting rod and has at least substantially the shape of a straight circular cylinder, is rotated about its longitudinal center axis relative to the connecting rod, and if the piston pin, which is at least partially received in the piston in the coupling areas of the piston pin and the piston, is rotated relative to the piston about the longitudinal center axis of the coupling area of the piston pin, which coupling area has at least substantially the shape of a straight circular cylinder, then, due to the eccentric arrangement of the eccentric element relative to the coupling area of the piston pin, the distance of the piston from the rotational axis of the crankshaft and the distance of the piston from a combustion chamber top of the combustion chamber in the direction of the longitudinal extent of the connecting rod are changed. This is accompanied by the change of the compression ratio of the combustion chamber. The method according to the invention thus enables a simple, uncomplicated as well as cost-effective and installation-space-saving adjustment of the compression ratio. Moreover, undesirable noise generation when adjusting or readjusting the compression ratio is avoided. Thus, the piston exhibits a particularly advantageous noise behavior (NVH behavior).

Moreover, it is possible to provide a conventional internal combustion engine, in which adjusting the compression ratio is not possible, in a simple and cost-effective manner with the device and to convert the conventional internal combustion engine without or only with minor changes to the piston of the conventional internal combustion engine into an internal combustion engine with variable compression ratio in which the method according to the invention can be carried out. At the same time, the internal combustion engine with the variable compression ratio has a particularly high percentage of parts that are identical to the conventional internal combustion engine.

The method according to the invention also enables a very rapid adjustment of the compression ratio so that the compression ratio can be adapted within a very short time to different operating points of the internal combustion engine. Thus, the internal combustion can be operated over a particularly long period with the appropriate compression ratio, which is beneficial for efficient and low-fuel operation of the internal combustion engine with only low emissions.

It is preferably provided that for effecting the rotation, at least one locking element of the device, which locking element is held at the piston pin, is moved relative to the piston pin and relative to the piston from a locking position preventing the rotation into a release position enabling the rotation. As a result, the rotation of the piston pin relative to the piston takes place due to centrifugal and/or inertial forces of the piston moving in the combustion chamber, and/or due to pressure forces in the combustion chamber. This means that active actuators for rotating the piston pin relative to the piston are not provided and are not needed. Rather, the rotation of the piston pin relative to the piston takes place passively. In this way, the weight and the complexity of the internal combustion engine is kept low so that the latter has a particularly high functional reliability.

In order to support this passive adjustment of the piston relative to the connecting rod and thus to support the adjustment of the compression ratio, it is advantageously provided that a crank chamber of the crankcase, which crank chamber is associated with the combustion chamber and the piston, is sealed by means of at least one actuator element with respect to at least one further chamber, in particular a crank chamber, of the crankcase, which further chamber is connected to the crank chamber. This is carried out in such a manner that the actuator element is displaced from a first position into a second position, which, in comparison to the first position, seals the crank chamber with respect to the further chamber. By sealing the crank chamber with respect to the further chamber, the pressure prevailing in the crank chamber is increased, which causes the displacement of the piston relative to the connecting rod.

The actuator element, for example, is a lubricating oil deflector in the crank chamber. The lubricating oil deflector can be switched and is at least substantially gas-tight so that the lubricating oil deflector is able to at least substantially seal the crank chamber.

Furthermore, by means of the actuator element at least one ventilation opening of the crank chamber can be substantially blocked and unblocked. In the second position of the actuator element, the ventilation opening is blocked with respect to the first position of the actuator element and thus is switched into an at least substantially gas-tight position, resulting in a pressure increase in the crank chamber of the first position.

In another embodiment of the invention the actuator element is displaced automatically from the second into the first position when the pressure in the crank chamber exceeds a threshold value. In this manner, undesirable high pressure built-up in the crank chamber can be avoided.

Automatic adjustment of the actuator element is implemented, for example, in such a manner that a spring element is provided that interacts with the actuator element. Here, the actuator element is kept in the second position under the spring force action by the spring element. If the pressure in the crank chamber reaches or exceeds the predeterminable threshold value, the actuator element is displaced by the pressure, against the spring force action by the spring element, from the second position into the first position. In the first position, the crank chamber can be vented so that the pressure in the crank chamber is released. Once the pressure in the crank chamber drops below the threshold value, the actuator element is displaced under the spring force action by the spring element back into its position in which the crank chamber, compared to the first position, is sealed with respect to the further chamber.

By displacing the at least on actuator element, the pressure in the crank chamber can be appropriately adapted and controlled, in particular feedback-controlled, for the adjustment or readjustment of the compression ratio.

In another advantageous embodiment it is provided that a balance shaft, in particular for Lanchester-balancing, of the internal combustion engine is used as a switching drum in order to avoid undesirable high pressure in the crank chamber. This also enables appropriate adjustment of the pressure in the crank chamber.

Further advantages, features and details of the invention are apparent from the following description of a preferred exemplary embodiment and from the drawing. The features and feature combinations mentioned above in the description as well as the features and feature combinations specified in the following description of the figures and/or shown alone in the figures can be used not only in the respective mentioned combination, but also in other combinations or alone, without departing from the context of the present invention.

### BRIEF DESCRIPTION OF THE DRAWING FIGURES

In the figures:

FIG. 1 shows a schematic perspective view of a piston pin with a locking element and a piston pin bushing of a piston arrangement shown in FIG. 3;

FIG. 2 shows a schematic perspective view of the piston pin according to FIG. 1;

FIG. 3 shows a partial schematic side view of a piston arrangement for a cylinder of a reciprocating piston engine with variable compression ratio, with a transparently drawn piston which is coupled in an articulated manner via the piston pin according to FIGS. 1 and 2 to a connecting rod of the piston arrangement, wherein the piston arrangement comprises a device by means of which the compression rate can be adjusted;

FIG. 4 shows a schematic side view of the piston according to FIG. 3, wherein a control element of the device is in a first position;

FIG. 5 shows another schematic side view of the piston according to FIG. 4;

FIG. 6 shows another schematic side view of the piston according to the FIGS. 4 and 5, wherein the control element is in its second position;

FIG. 7 shows another schematic side view of the piston according to FIG. 6;

FIGS. 8a-e each show a schematic side view of the piston arrangement according to FIG. 3 during a stroke movement in the cylinder, wherein the compression ratio is adjusted,

FIG. 9 shows a partial schematic perspective view of the piston according to FIG. 3;

FIG. 10 shows another partial schematic perspective view of the piston according to FIG. 9;

FIG. 11 shows a schematic perspective view of the piston according to the FIGS. 9 and 10, wherein the piston is shown in a transparent illustration; and

FIG. 12 shows a partial schematic perspective view of the piston according to FIG. 11, wherein the piston is shown in a transparent illustration.

### DETAILED DESCRIPTION

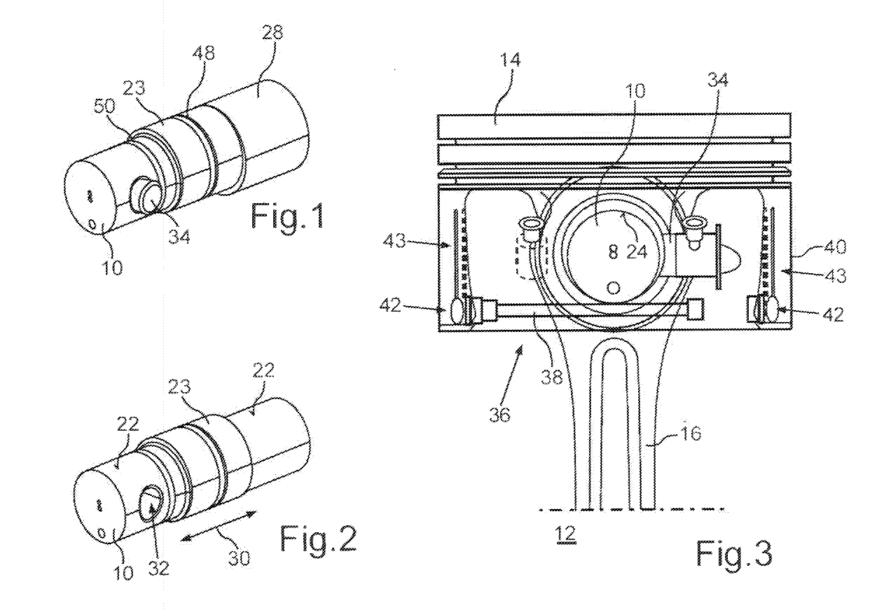

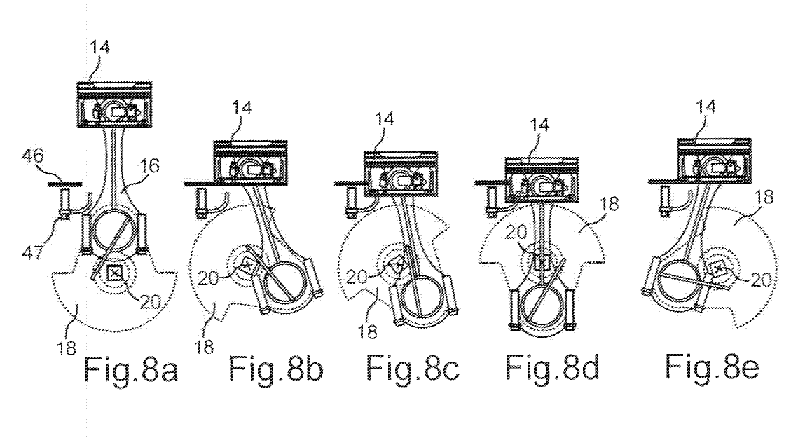

FIGS. 1 and 2 show a piston pin 10 of a piston arrangement 12 (FIG. 3), via which a piston 14 of the piston arrangement is to be coupled in an articulated manner to a connecting rod 16 of an internal combustion engine that is implemented as a reciprocating piston engine. As can be seen in connection with the FIGS. 8a-e, the internal combustion engine comprises a crankshaft 18 which is mounted in a crankcase to be rotatable relative to the crankcase about a rotational axis 20. The crankshaft 18 comprises a crankpin at which the connecting 16 is mounted in an articulated manner via a big end bore of the connecting rod. The connecting rod 16 further comprises a small end bore in which the piston pin 10 is received in certain areas.

The piston pin 10 is coupled to the piston 14 via respective coupling areas 22. The coupling areas 22 of the piston pin 10 are formed by a surface shell on the outer circumference of the piston pin 10, wherein the coupling areas are formed at least substantially in the form of a straight circular cylinder. For coupling the piston pin 10 to the piston 14, the coupling areas 22 are received at least in certain areas in respective receiving openings 26 of the piston 14, which, in the present case, are formed as through-openings.

The piston pin 10 is indirectly connected to the piston 14—with regard to the image plane of FIG. 2—via the right coupling area 22 of the piston pin 10. As can be seen from FIG. 1, the piston arrangement 12 comprises a piston pin bushing 28 in which the right coupling area 22 of the piston pin 10 is arranged. The piston pin bushing 28 is received in the corresponding receiving opening 26. The piston pin bushing 28 functions here as a stop for the piston 10 and enables simple mounting of the piston pin 10 at or in the piston 14.

The piston pin 10 has an eccentric element 23 formed at least substantially in the form of a straight circular cylinder and is arranged eccentrically with regard to coupling areas 22. This means that the longitudinal center axis of the eccentric element is offset perpendicular to the respective longitudinal center axes of the coupling areas 22, which longitudinal center axes are arranged coaxial to each other. The piston pin 10 is connected in an articulated manner to the connecting rod 16 via the eccentric element 23, which is received at least in certain areas in the small end bore of the connecting rod 16. Thus, the piston 14 is coupled in an articulated manner to the connecting rod 16. As a result of this articulated coupling, translational relative movements of the piston 14, which is received in a cylinder of the internal combustion engine, relative to the cylinder can be converted into a rotational movement of the crankshaft 18 about the rotational axis.

As is particularly apparent from FIG. 2, the piston pin 10, which has a longitudinal extent indicated by a direction arrow 30, has a receiving opening 32 which is formed, for example, as a through-opening. The receiving opening 32 extends at least substantially perpendicular to the longitudinal extent (direction arrow 30) of the piston pin 10.

A locking element in the form of a locking pin 34 is received in the receiving opening 32. In the receiving opening 32, the locking pin 34 can be moved relative to the piston pin 10 in a guided manner perpendicular to the longitudinal extent of the piston pin 10. In connection with the FIG. 3 it is apparent that at least the piston pin 10 and the locking pin 34 are associated with a device 36 of the piston arrangement 12. By means of the device 36 it is possible to variably adjust the compression ratio of the internal combustion engine cylinder that is associated with the piston arrangement 12.

For this purpose, the device 36 also comprises a control element in the form of a control slide 38. The control slide 38 is held at the piston 14 and is movable relative to the piston 14 and relative to the piston pin 10 between two positions. The control slide 38 can be moved only between the two positions. The control slide 38 thus is a so-called bistable control piston.

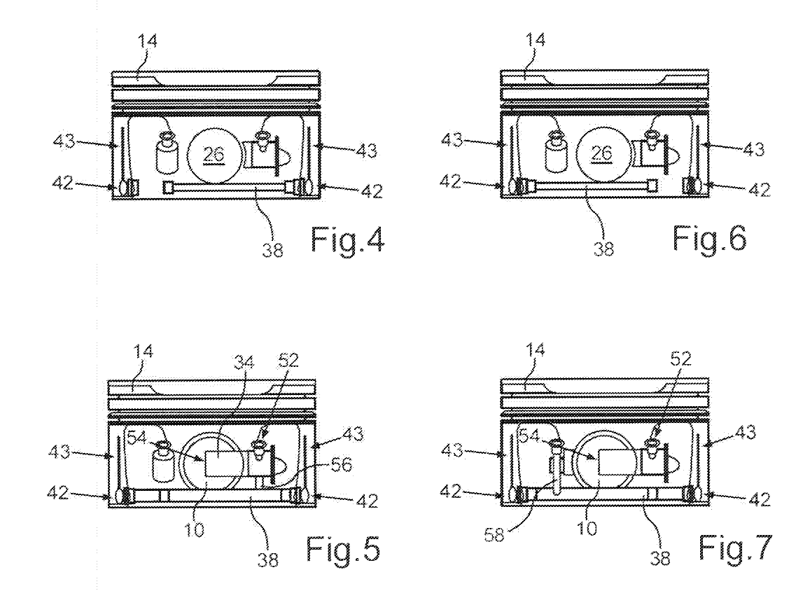

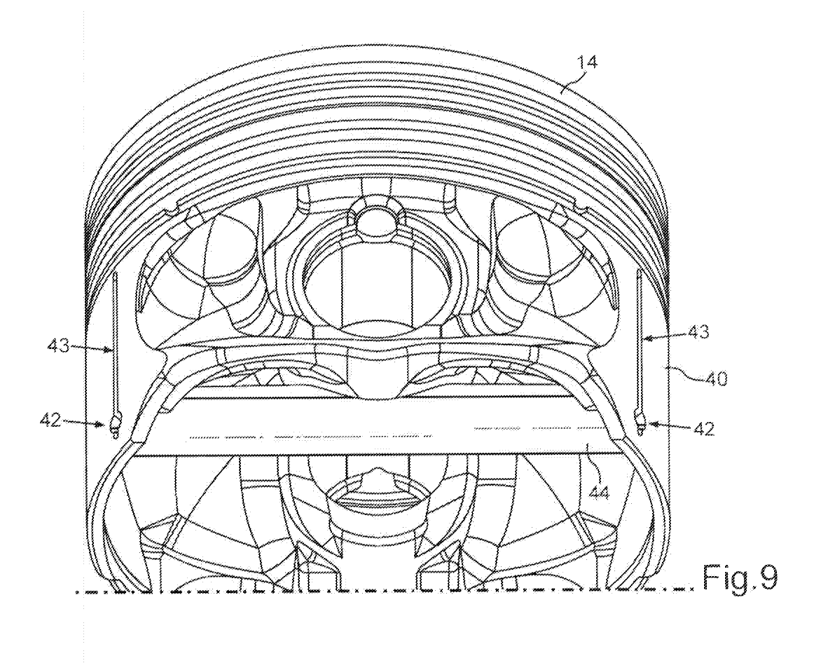

In a first position of the control slide 38, which is in particular shown in the FIGS. 4 and 5, the control slide is held by means of a first magnet. The first magnet is arranged on the piston 14. In the second position, which is in particular shown in the FIGS. 3, 6 and 7, the control slide 38 is held by means of a second magnet, the second magnet also being held on the piston 14. FIG. 9 shows in particular a sleeve 44 of the device 36, in which sleeve the control slide 38 is received in a displaceable manner.

By displacing the control slide 38 at least substantially perpendicular to the longitudinal extent of the piston pin 10 between its two positions, a movement of the locking pin 34 between a release position and a locking position of the locking pin 34 can be effected, or can be prevented or locked. Displacing the control slide 38 between its two positions can be carried out again by means of an actuator, for example, an electromagnet, or by means of oil pressure. In the present case, the control slide 38 is displaced by means of oil pressure.

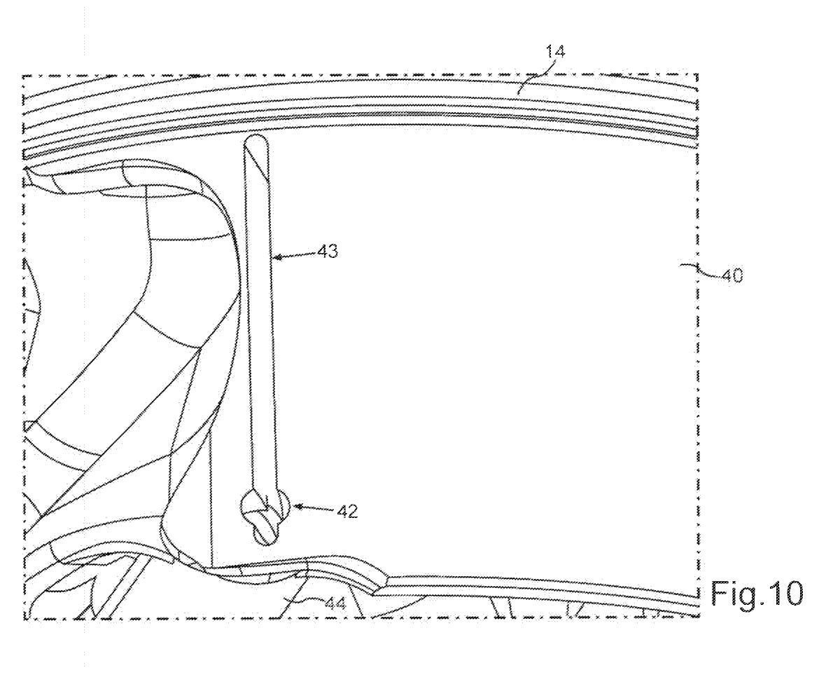

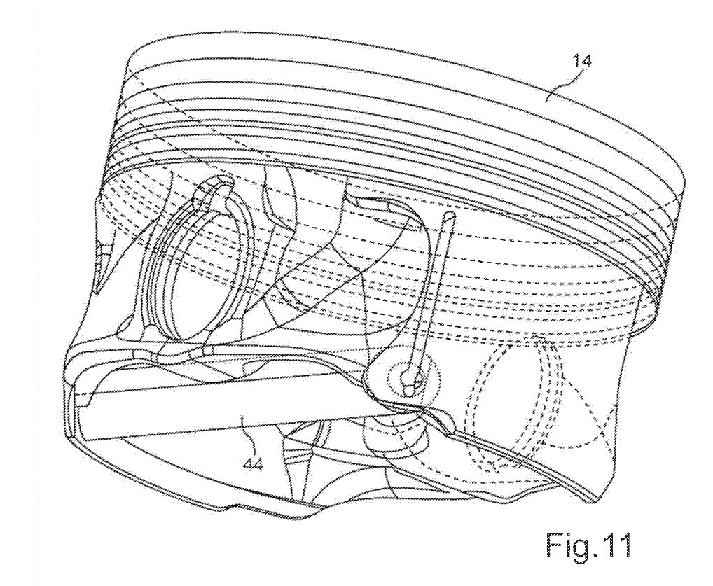

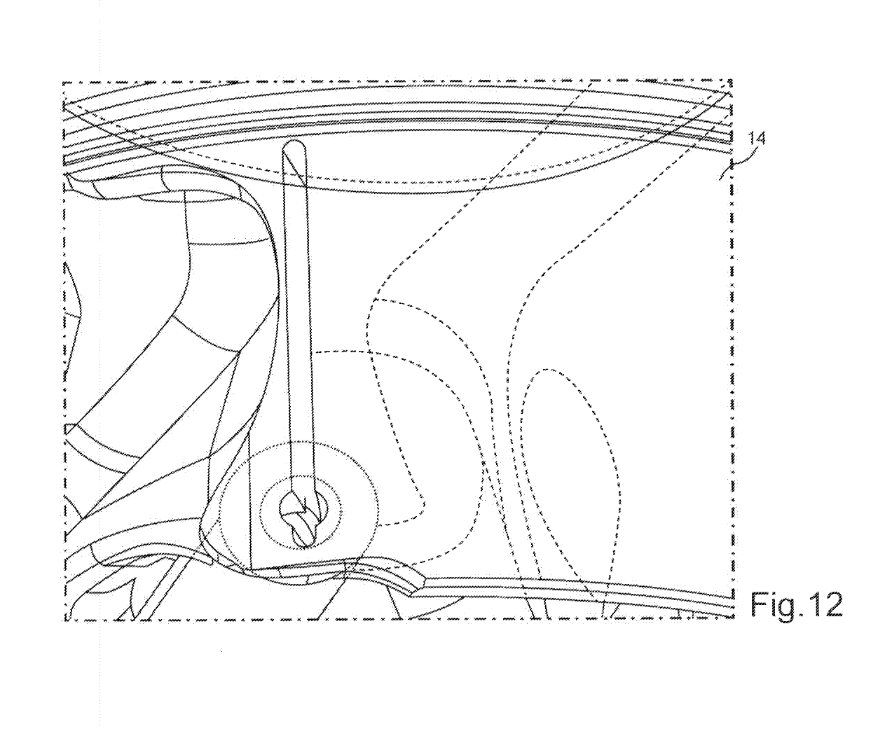

As is apparent from the FIGS. 9 to 12, the piston 14 has in its piston skirt 40 two through-openings 42 that are located opposite one another. The through-openings 42 pass completely through the piston skirt 40 and thus through a surface shell on the outer circumference of the piston 14. Grooves 43 adjoin the through-openings, which grooves run in the axial direction of the piston 14 and are connected to the through-openings 42. In other words, the grooves 43 end in the through-openings.

The readjustment of the compression ratio can be seen in particular in the FIGS. 8a-e. Via an activation element 46, for example an oil injection nozzle, lubricating oil of the internal combustion engine is injected into the grooves 43 and into the through-openings 42 while the piston 14 moves in the cylinder. Thereby the control slide 38 is acted on, in particular pressurized, at one of its front sides by lubricating oil. Activating using the lubricating oil takes place here through a crank angle of the crankshaft 18 of 150°, wherein the pressurization, i.e., the activations of the control slide 38 begins at a rotational position of the crankshaft 18 according to FIG. 8b and ends at a further rotational position of the crankshaft 18 according to FIG. 8e. The respective other front side of the control slide 38 that is located in each case opposite the front side that is acted on with lubricating oil is not acted on with lubricating oil, which is ensured, for example, by reciprocally locked control valves. By acting on the one front side of the control slide 38, the control slide 38 is displaced in the direction of the other front side which is not acted on with lubricating oil. FIGS. 8a-e also show an oil injection nozzle 47 by means of which lubricating oil can be sprayed onto the piston 14, and the piston thus can be cooled.

The activation element 46 is arranged here in the cylinder wall of the cylinder. In other words, pressurization or activation of the control slide 38 is carried out from outside of the piston 14 via the cylinder wall and thus from outside of the piston 14.

The grooves 43, which can also be formed as oblong holes, serve for receiving the lubricating oil via the rotation of the crankshaft 18 and thus via the translational movement of the piston 14 in the cylinder and feed the lubricating oil to through-openings 42 and from there to the control slide 38.

The control slide 38 serves for the so-called pilot control of the lubricating oil of the internal combustion engine, by means of which the locking pin 34 is moved between at least one release position and at least one locking position of the locking pin 34.

The lubricating oil for displacing the locking pin 34 is fed to the crankshaft 18 via bearing seats for the crankshaft 18 at the crankcase and is delivered via corresponding channels to the connecting rods 16. From the connecting rod 16, the lubricating oil flows to a first groove 48 of the piston pin 10, which first groove extends in the circumferential direction over the entire outer circumference of the piston pin. From the first groove 48, the lubricating oil flows via at least one corresponding connection channel to a second groove 50 of the piston pin 10, which second groove likewise extends in the circumferential direction of the piston pin 10 over the entire outer circumference thereof. From the second groove 50, the lubricating oil can flow to corresponding channels 56, 58 in the piston 14. Depending on the position of the control slide 38, the lubricating oil can flow through the first channel 56 or through the second channel 58, can reach the locking pin 34 and can move the same. The channels 56, 58 are integrated directly in the piston 14, that is, are formed or bordered by walls of the piston 14. The oil flowing out at the control slide 38 through the through-opening 42 during switching can be used for cooling. The connection channel of the grooves 48, 50 has to ensure the pressure built-up downstream of the locking pins and therefore should not have any unnecessary leakage to the outside.

FIG. 5 shows the control slide 38 in its first position. In the first instance, the locking pin 34 is in its locking position in which the locking pin interacts with the piston 14 (with regard to the image plane of FIG. 5) on the side of the right groove 43 and prevents the piston pin 10 from rotating relative to the piston 14. This means that the piston pin 10 can only be rotated in the small end bore of the connecting rod 16 about the longitudinal center axis of the eccentric element 23 relative to the connecting rod 16 so that the piston 14 is coupled in an articulated manner to the connecting rod 16 via the piston pin 10. For this purpose, the locking pin 34 is received in certain areas in the receiving opening 32 and in certain areas in a first receptacle in the piston 14, which receptacle is arranged on the side of the right groove 43.

In the first position of the control slide 38, the first channel 56 in the piston 14 can be supplied with lubricating oil. Supplying the second channel 58 in the piston 14 with lubricating oil is prevented by the control slide 38. As is apparent from FIG. 5, the lubricating oil flows in the first position of the control slide 38 from the connecting rod 16 via the grooves 48, 50 into the right first channel 56 and from there further to a first front side 52 of the locking pin 34, which first front side is on the right side in this position of the piston pin 10. This means that the first front side 52 is acted on by the lubricating oil. The lubricating oil now pushes the locking pin 34 in the radial direction of the piston pin 10 into the receiving opening 32, and thus from its locking position into its release position.

In the receiving position 32, a spring element can be arranged via which the locking pin 34 is supported on the piston 10 under the action of the spring force. The spring force is directed outwards in the radial direction of the piston pin 10. This means that the lubricating oil then pushes the locking pin 34 against the spring force into the receiving opening 32 and out of the first receptacle. Once the locking pin 34 has moved completely out of the first receptacle, the locking pin is in its release position. In the release position, the locking pin 34 can no longer prevent a rotation of the piston pin 10 relative to the piston 14. The piston pin 10 can then be rotated in the small end bore of the connecting rod 16 about the longitudinal center axis of the eccentric element 23 relative to the connecting rod 16, and can be rotated in the receiving openings 26 about the respective longitudinal center axes of the coupling areas 22 relative to the piston 14.

Such a relative rotation is effected, for example, by inertial and/or centrifugal forces, or by pressure forces that prevail in the cylinder and act on the piston 14 due to the eccentric arrangement of the eccentric element 23 relative to the coupling areas 22. During the compression stroke of the piston 14, the piston 14 is pushed in the direction of the rotational axis 20. Due to the eccentric arrangement of the eccentric element 23 relative to the coupling areas 22, the spacing between the piston 14 and the rotational axis is reduced or, respectively, the spacing between the piston 14 and a combustion chamber top of the cylinder is increased, as a result of which the compression ratio (ε) is reduced. During the intake stroke, the spacing between the piston 14 and the rotational axis 20 is increased by pulling the piston 14 away from the rotational axis. Thereby, a correspondingly higher compression ratio is set. Pushing and pulling the piston 14 via its coupling to the piston pin 10 effects a rotation of the piston pin 10 relative to the piston 14 and/or relative to the connecting rod 16 when the locking pin 34 is in its release position.

In the present case, the piston pin 10 rotates by 180 degrees (with regard to the image plane of FIG. 5) to the left, thus counterclockwise. If the receiving opening 32 is formed as a through-opening, the lubricating oil then acts via the first right channel 56 on a second front side 54 of the locking pin 34, which second front faces away from the first front side 52, and, together with the spring force of the spring element, pushes the locking pin 34 in the radial direction outwards and out of the receiving opening 32. Thus, the locking pin 34 is moved again from its release position into its locking position. Then, the locking pin 34 interacts with the piston 14 (with regard to the image plane of FIG. 5) on the side of the left groove 43 so that then a rotation of the piston pin 10 relative to the piston 14 is prevented again. The piston pin 10 is locked.

To this end, for example, the locking pin 34 is received in certain areas in the receiving opening 32 and is received in certain areas in a second receptacle in the piston 14, which second receptacle is arranged on the side of the left groove 43. The lubricating oil can be used not only for moving the locking pin 34, but also for blocking the locking pin in the locking position and thus also fulfills a blocking function. If, based on this, the control slide 38 is moved (displaced) into its second position, the supply of lubricating oil to the right first channel 56 is terminated. Then, the left second channel 58 is supplied with lubricating oil. The lubricating oil can then flow from the piston 16 via the grooves 48, 50 into the left second channel 58 and from there to the first front side 52 which is on the left in the current position of the piston pin. This means that now the first front side 52 (no longer the second front side 54) is acted on again with lubricating oil. The lubricating oil pushes the locking pin 34 into its release position again.

The piston pin can now rotate again by 180 degrees, but this time to the right, thus clockwise. This, in turn, is not effected by an active actuator element, but is effected substantially passively by centrifugal and/or inertial and/or pressure forces.

As is apparent from FIG. 7, then—after the rotation to the right—the second front side 54 is acted on with lubricating oil, but this time via the second channel 58. Together with the spring force, the locking pin 34 is thereby pushed in its locking position on the side of the right groove 43 and is blocked by means of the lubricating oil. The piston pin 10 is locked again.

This means that depending on the position of the control slide 38 and the rotational position of the piston pin 10 in the receiving openings 26 either the first front side 52 or the second front side 54 is acted on with lubricating oil and the locking pin can be moved (displaced) accordingly, or the locking pin 34 is blocked, as a result of which the piston pin 10 is locked in the dead centers of the piston 14.

It can be seen that by means of the one control slide 38, two positions of the piston pin 10 and therefore two different compression ratios of the cylinder can be achieved by means of the piston arrangement 12. At least one further control slide, such as the control slide 38, can be provided so that by means of the further control slide, two further positions of the piston pin 10 and therefore two further compression ratios can be achieved. For achieving the two further compression ratios, for example, the piston pin 10 is coupled to the piston via its coupling areas 22 by interposing respective eccentric bushings. This means that the piston 14 is mounted on the piston pin 10 via the eccentric bushings. Analogous to the rotation of the piston pin 10 relative to the piston 14 by displacing the control slide 38, rotations of the eccentric bushings relative to the piston 14 can then be effected by means of the further control slide so that thereby the piston 14 is displaced relative to the rotational axis 20 and relative to the combustion chamber top.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-6. (canceled)

7. A method for variably adjusting a compression ratio of a combustion chamber of an internal combustion engine, the method comprising:
actuating a device of a piston associated with the combustion chamber and coupled via respective coupling areas to a piston pin connecting the piston to a connecting rod of the internal combustion engine, wherein the actuation of the device causes the piston pin to rotate, wherein the piston pin comprises at least one eccentric element arranged eccentrically with regard to the coupling area of the piston pin and which connects the piston pin to the connecting rod, and wherein to rotate the piston pin at least one locking element of the device is moved relative to the piston pin and relative to the piston from a locking position preventing the rotation into a release position enabling the rotation, wherein the rotation of the piston pin relative to the piston occurs by centrifugal or inertial forces of the piston moving in the combustion chamber or as a result of pressure forces in the combustion chamber; and
sealing a crank chamber of a crankcase by at least one actuator element with respect to at least one further chamber of the crankcase, wherein the crank chamber is associated with the combustion chamber and with the piston, a crankshaft is arranged at least in certain areas in the crankcase, wherein said further chamber is connected to the crank chamber by displacing the actuator element from a first position into a second position which, with regard to the first position, seals the crank chamber with respect to the further chamber.

8. The method according to claim 7, wherein as the actuator element, a lubricating oil deflector in the crank chamber is displaced.

9. The method according to claim 7, wherein as the actuator element, a valve element is displaced which, in the first position, opens a ventilation opening of the crank chamber at least in certain areas, and in the second position, closes the ventilation opening at least in certain areas with respect to the first position.

10. The method according to claim 7, wherein the actuator element moves automatically, under action of a spring force applied by a spring element, from the second into the first position when the pressure in the crank chamber exceeds a threshold value.
